(19) United States
(12) Patent Application Publication
(10) Pub. No.: US 2011/0173504 A1
(43) Pub. Date: Jul. 14, 2011

(54) COMMUNICATION SYSTEM, A COMMUNICATION METHOD AND A PROGRAM THEREOF

(75) Inventor: Masanori KABAKURA, Tokyo (JP)

(73) Assignee: NEC CORPORATION, Tokyo (JP)

(21) Appl. No.: 13/005,299

(22) Filed: Jan. 12, 2011

(30) Foreign Application Priority Data
Jan. 13, 2010 (JP) 005022/2010

(51) Int. Cl. G06F 11/07

(52) U.S. Cl. 714/48; 714/E11.024

(57) ABSTRACT

A communication system capable of identifying a path where a fault has occurred when the fault is detected. The communication system has a host computer with a host port, a switch with a switch port and a storage device with a storage port which is connected to the host port via the switch port. The host computer manages access path information indicating how the host port and the storage port are connected to the switch port, and identifies an access path influenced by a switch fault according to the access path information when the switch fault occurs.

This application is based upon and claims the benefit of priority from Japanese patent application No. 2010-005022, filed on Jan. 13, 2010, the disclosure of which is incorporated herein in its entirety by reference.

### BACKGROUND

The present invention relates to a communication system, a communication method and a program thereof. More particularly, it relates to a communication system, a communication method and a program thereof having a host computer, a switch unit and a storage device.

In a related technology, it is possible to detect that an connection with a storage device has been cut by link down and that a work I/O or a monitor I/O detects an error. However, it is not possible to detect a fault recoverable at a layer lower than a path management program, such as instantaneous link down and a CRC error, which does not cause an I/O error or cut-off of connection. Such a fault causes performance deterioration because retransmission of I/O is required. Therefore, it is necessary to detect the fault.

It is difficult to specify where on the route a fault has occurred by the path management program when the fault is detected.

An example of a related computer system is described in Japanese Patent Laid-Open No. 2007-47986 (Patent Literature 1). This computer system is a system which realizes integrated management of the component lines of a storage system and optimum arrangement of resources. In addition, a fault position identifying method for a storage device is described in Japanese Patent Laid-Open No. 2008-158666 (Patent Literature 2) and Japanese Patent No. 4256912 (Patent Literature 3).

However, Patent Literature 1 has problems shown below. A first problem is that this computer system is not applicable to a large-scale computer system. The reason is that a configuration in which switch units are connected with one another is not considered.

A second problem is that much time is required until a fault path is identified after a fault is detected. The reason is that all paths are searched after the fault is detected to judge whether each path is related to a fault occurrence position.

Patent Literature 1 to 3 have a problem that only the form of FC (FibreChannel) connection is handled as the configuration of a storage area network, and connection among switches is not considered in any of them. Especially in the case of handling network connection such as iSCSI (Internet Small Computer System Interface) and FCoE (Fibre Channel over Ethernet (registered trademark)), it is necessary to consider the configuration of connection among switches. However, in the methods of Patent Literature 1 to 3, it is not possible to find a fault occurrence position when there is connection among switches.

An object of a certain example of the present invention is to provide a communication system and communication method and a program thereof capable of identifying a fault occurrence position by acquiring error information at a switch unit and comparing the error information with route connection information when a fault occurs.

### SUMMARY OF THE INVENTION

A non-limiting feature of certain embodiments of the invention provides a communication system capable of identifying a path where a fault has occurred when the fault is detected. The communication system has a host computer with a host port, a switch with a switch port and a storage device with a storage port which is connected to the host port via the switch port. The host computer manages access path information indicating how the host port and the storage port are connected to the switch port, and identifies an access path influenced by a switch fault according to the access path information when the switch fault occurs.

A non-limiting feature of certain embodiments of the invention provides a communication system capable of detecting such a fault that cannot be detected from a path management program even in a large-scale configuration in which a lot of switch units are connected. The communication system has a host computer with a host port, a switch with a switch port and a storage device with a storage port which is connected to the host port via the switch port. The host computer manages statistical information including the number of switch faults, and detects an occurrence of the switch fault when the number of the switch faults is over a predetermined threshold.

According to another feature of the invention, there is provided a communication system capable of identifying a path where a fault has occurred when the fault is detected. The communication system has a host computer with a host port, a switch with a switch port, a storage device with a storage port which is connected to the host port via the switch port and a management computer. The management computer manages access path information indicating how the host port and the storage port are connected to the switch port, and identifies an access path influenced by a switch fault according to the access path information when the switch fault occurs.

According to another feature of the invention, there is provided a communication system capable of detecting such a fault that cannot be detected from a path management program even in a large-scale configuration in which a lot of switch units are connected. The communication system has a host computer with a host port, a switch with a switch port, a storage device with a storage port which is connected to the host port via the switch port and a management computer. The management computer manages statistical information including the number of switch faults, and detects an occurrence of the switch fault when the number of the switch faults is over a predetermined threshold.

According to another feature of the invention, there is provided a communication method of a communication system capable of identifying a path where a fault has occurred when the fault is detected. The computer system has a host computer with a host port, a switch with a switch port and a storage device with a storage port. The communication method has steps of connecting the storage port to the host port via the switch port; managing access path information indicating how the host port and the storage port are connected to the switch port; and identifying an access path influenced by a switch fault according to the access path information when the switch fault occurs.

According to another feature of the present invention, there is provided a communication method of a communication system capable of detecting such a fault that cannot be detected from a path management program even in a large-scale configuration in which a lot of switch units are connected. The computer system has a host computer with a host port, a switch with a switch port and a storage device with a storage port. The communication method has steps of connecting the storage port to the host port via the switch port; managing statistical information including the number of switch faults; and detecting an occurrence of the switch fault when the number of the switch faults is over a predetermined threshold.

According to another feature of the present invention, there is provided a readable medium having recorded thereon a program for enabling a computer to carry out a method capable of identifying a path where a fault has occurred when the fault is detected. The computer has a host computer with a host port, a switch with a switch port and a storage device with a storage port. The method has steps of connecting the storage port to the host port via the switch port; managing access path information indicating how the host port and the storage port are connected to the switch port; and identifying an access path influenced by a switch fault according to the access path information when the switch fault occurs.

According to another feature of the present invention, there is provided a readable medium having recorded thereon a program for enabling a computer to carry out a method capable of detecting such a fault that cannot be detected from a path management program even in a large-scale configuration in which a lot of switch units are connected. The computer has a host computer with a host port, a switch with a switch port and a storage device with a storage port. The method has steps of connecting the storage port to the host port via the switch port; managing statistical information including the number of switch faults; and detecting an occurrence of the switch fault when the number of the switch faults is over a predetermined threshold.

### BRIEF DESCRIPTION OF THE DRAWING

The above and other aspects of the present invention will become more apparent by describing in detail exemplary embodiment thereof with reference to the attached drawings in which:

FIG. 1 is a diagram showing a communication system according to a first exemplary embodiment of the present invention.

FIG. 2 is a diagram showing a configuration of a communication system according to a second exemplary embodiment of the present invention.

FIG. 3 is a diagram showing path information.

FIG. 4 is a diagram showing switch information.

FIG. 5 is a diagram showing a storage network.

FIG. 6 is a diagram showing fault information.

FIG. 7 is a diagram showing network path information.

FIG. 8 is a diagram showing network switch information.

FIG. 9 is a flowchart showing a method for a storage network management program to create storage network information.

FIG. 10 is a flowchart showing the details of a registration procedure at step A7 in FIG. 9.

FIG. 11A is a flowchart showing a fault detection method according to a second exemplary embodiment of the present invention.

FIG. 11B is a flowchart showing the fault detection method according to the second exemplary embodiment of the present invention.

FIG. 12 is a diagram showing a specific example of the computer system.

FIG. 13 is a diagram showing storage network information 120a at the time when step A5 ends.

FIG. 14 is a diagram showing the storage network information 120a at the time when step A6 ends.

FIG. 15 is a diagram showing the storage network information 120a at the time when step A7 ends.

FIG. 16 is a diagram showing fault information 130a at the time when step B4 ends.

FIG. 17 is a diagram showing path information 230a immediately before step B6.

FIG. 18 is a diagram showing a computer system 1b according to a third exemplary embodiment of the present invention.

### DETAILED DESCRIPTION

The examplary embodiments to which the present invention is applied will be described below in detail with reference to drawings. In these embodiments, the present invention is applied to a communication system provided with a management computer, a host computer, a switch unit and a storage device. And the host computer, the switch unit and the storage device are connected by a storage cable. And the management computer, the host computer and the switch unit are connected via a communication network.

### First Exemplary Embodiment of the Present Invention

In the communication system according to this embodiment, a fault on a storage area network is judged based on statistical information about the switch unit and notified to a path management program on the host computer. Then, an access path is identified from a port where the fault has occurred.

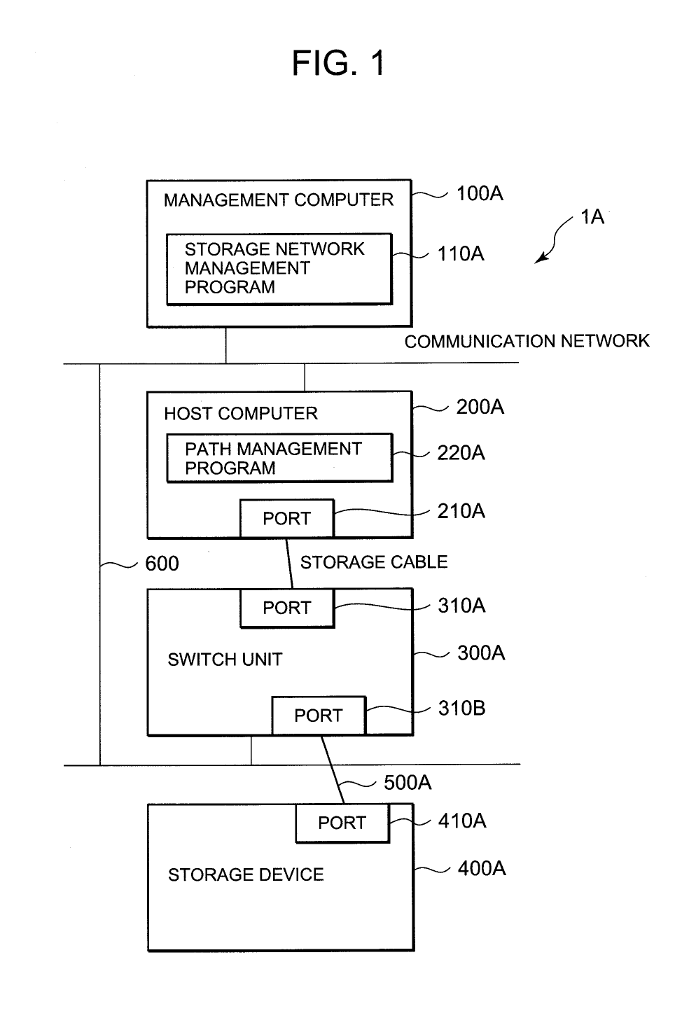

FIG. 1 is a diagram showing the communication system according to the exemplary embodiment of the present invention. As shown in FIG. 1, the communication system (hereinafter referred to as the calculator system) is provided with a management computer 100A, a host computer 200A, a switch unit 300A and a storage device 400A. The host computer 200A and the switch unit 300A and the storage device 400A are connected by a storage cable 500A, and the management computer 100A, the host computer 200A and the switch unit 300A are connected via a communication network 600.

The management computer 100A has a storage network management program 110A which generates network path information. The host computer 200A has one or more host ports 210A and a path management program 220A which detects a fault on the network by receiving fault information. The switch unit 300A has one or more switch ports 310A and 310B, and the storage device 400A has one or more storage ports 410A.

The storage network management program 110A periodically acquires path information and switch information from the host computer 200A and the switch unit 300A, respectively. The path information is information about an access path with a certain host port as a start point and a certain storage port as an end point. The switch information is information including connection destinations of the switch ports 310A and 3108 and the number of error detections.

And the storage network management program 110A creates/updates the network path information indicating the connection destination of each port and the state thereof on the basis of the path information and the switch information.

Then, when a fault occurs, the storage network management program 110A creates fault information from the switch information and the network path information and transmits the fault information to the path management program 220A on each host computer 200A. Thereby, each host computer 200A can detect the fault and identify a fault occurrence position. That is, it is possible to detect a recoverable fault which has occurred at a layer lower than the path management program, and it is also possible to identify where on the route the fault has occurred when the fault is detected.

### Second Exemplary Embodiment of the Present Invention

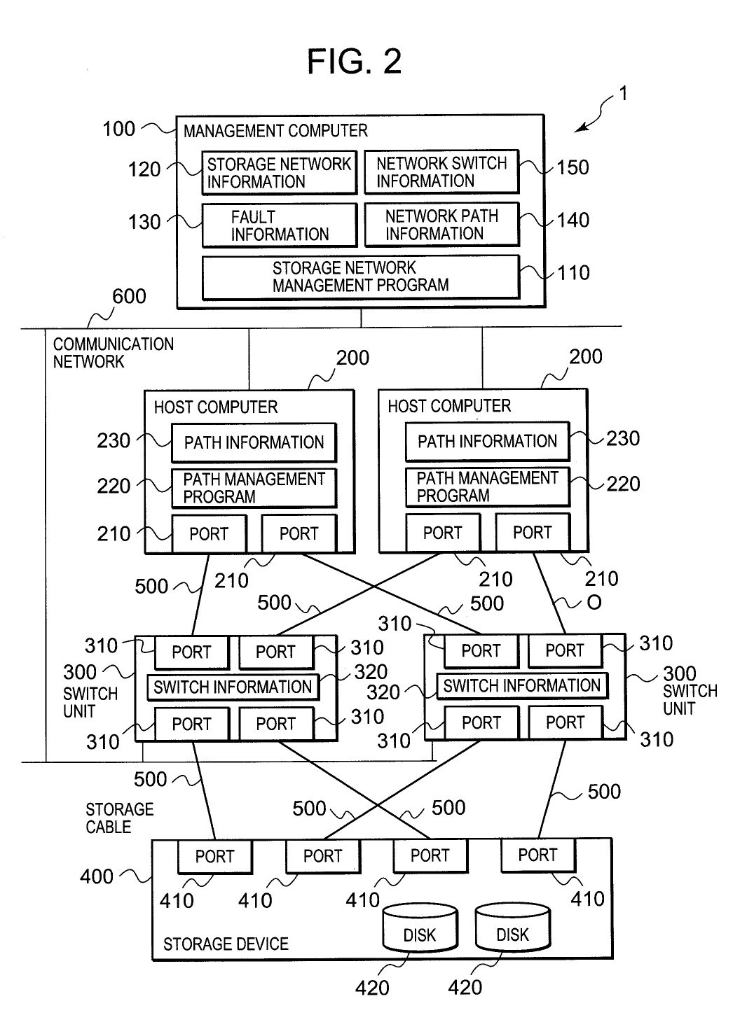

In the first exemplary embodiment described above, one host computer and one switch unit are provided. In this embodiment, however, two host computers and two switch units are provided. The storage device is provided with a disk as a storage section. FIG. 2 is a diagram showing the configuration of a communication system according to this embodiment.

As shown in FIG. 2, a calculator system 1 according to this embodiment is configured by one management computer 100, one or more host computers 200, one or more switch units 300, and one or more storage devices 400.

On the management computer 100, a storage network management program 110 operates, and the management computer 100 has one piece of storage network information 120, one piece of fault information 130, one piece of network path information 140 and one piece of network switch information 150.

The network path information 140 functions as a path information storage section which stores path information 230 periodically sent from the host computers 200. The network switch information 150 functions as a switch information storage section which stores switch information periodically sent from the switch unit 300.

The host computer 200 can be identified by a computer identifier 201. The host computer 200 has an arbitrary number of host ports 210. One path management program 220 operates on the host computer 200, and the host computer has one piece of path information 230. The path information 230 is configured by a table having access path information as described later. Each host port can be identified by a host port identifier 231.

The switch unit 300 can be identified by a switch identifier 301. The switch unit 300 has two or more switch ports 310 and one piece of switch information 320. The switch information is a table having information about connection destinations of the switch ports and statistical information including the number error detections, as described later. Each switch port can be identified by a switch port identifier 321.

The storage device 400 has one or more target ports (storage ports) 410 and an arbitrary number of disks 420. Each target port can be identified by a target port identifier 411.

The host ports 210, the switch ports 310 and the target ports 410 will be collectively referred to as ports. Two ports can be connected by a storage cable 500. In the storage area network, the storage cable 500 corresponds to an FC cable or a network cable.

A route passed through to access to a certain disk 420 from a certain host computer 200 will be called an access path. The access path is a route with one host port 210 on the host computer 200 as a start point and one storage port 410 on the storage device 400 where a disk 420 exists as an end point, and the access path passes through an arbitrary number of switch ports 310 connected by the storage cable 500.

A loop must not exist on one access path. That is, there must not exist, for a certain access path, such a route that the same ports are passed through several times.

The host port identifier 231, the switch port identifier 321 and the target port identifier 411 will be referred to as port identifiers. The port identifier and the computer identifier 201 will be referred to simply as identifiers. Each identifier is unique in the calculator system of this configuration example.

The management computer 100 and each host computer 200 are connected, and the management computer 100 and each switch unit 300 are connected via the route information communication network 600.

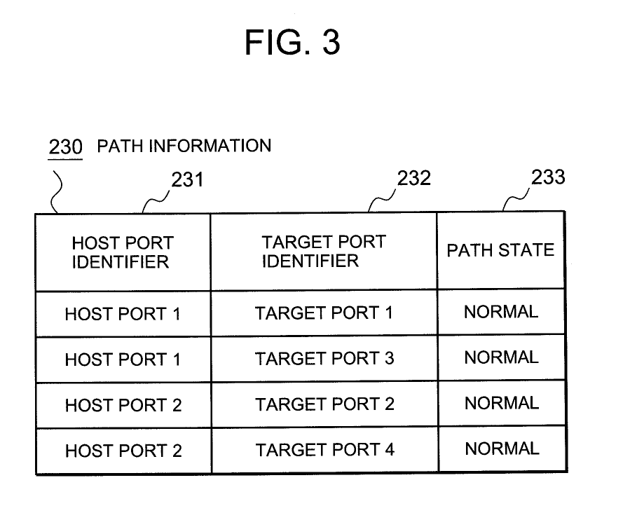

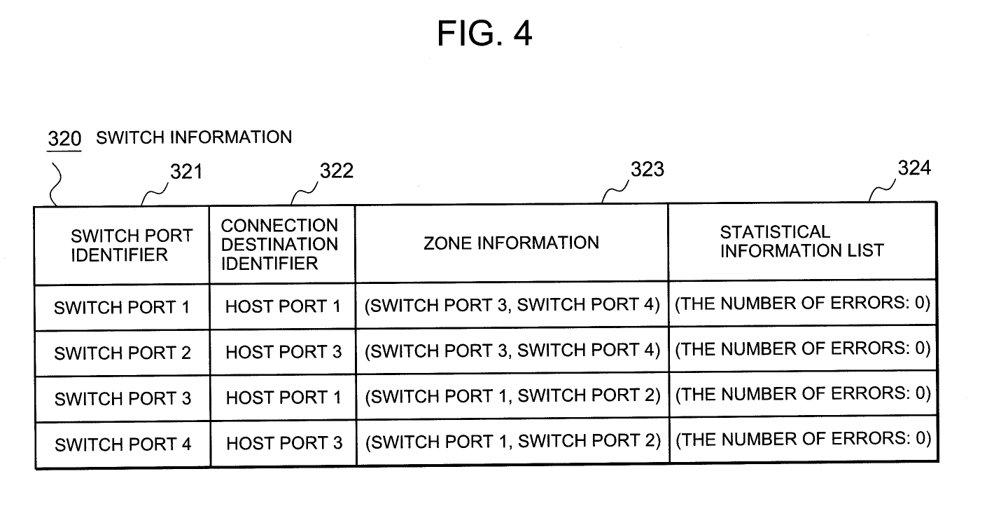

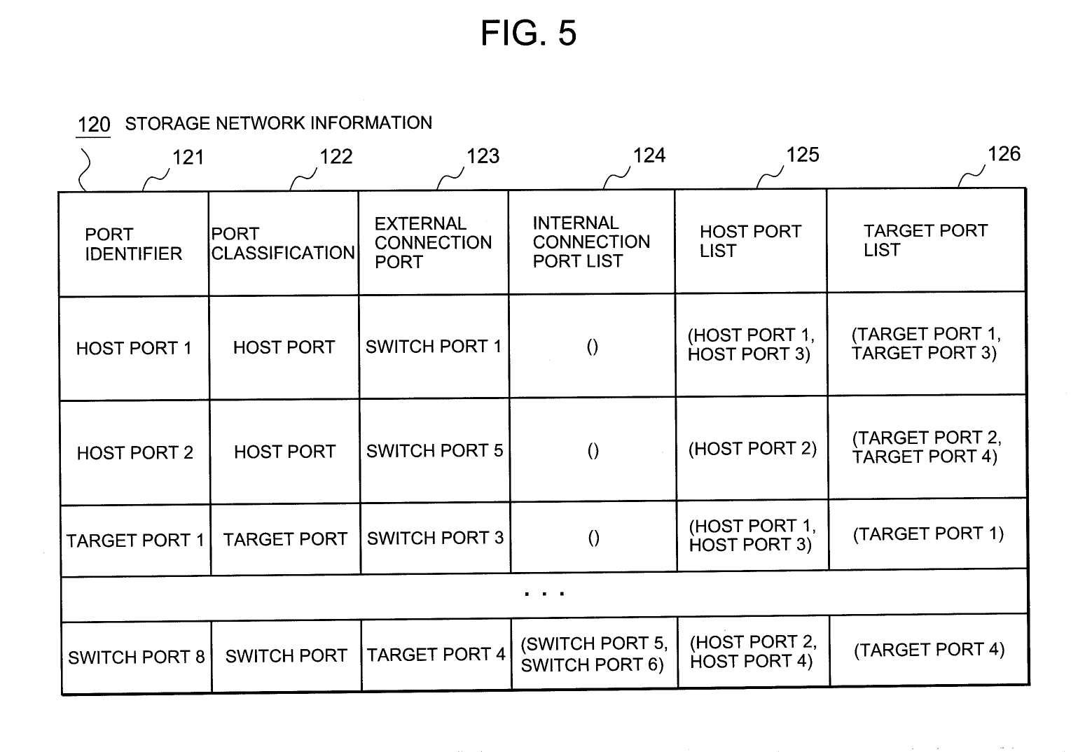

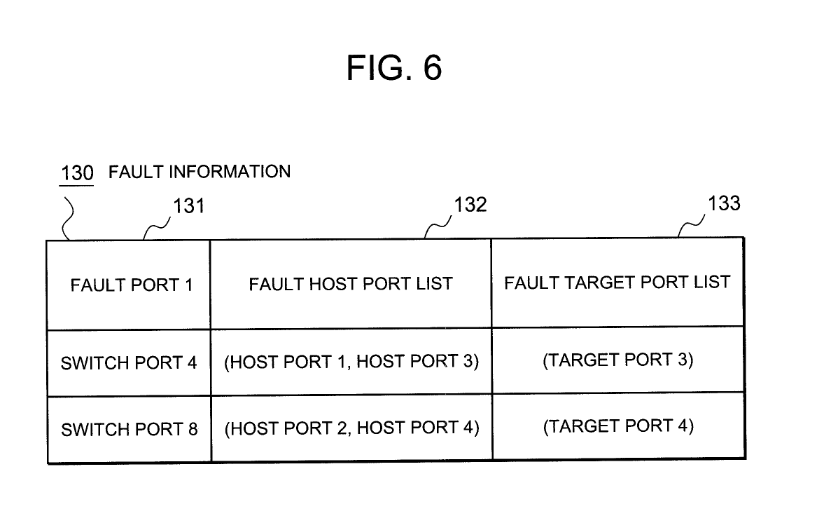

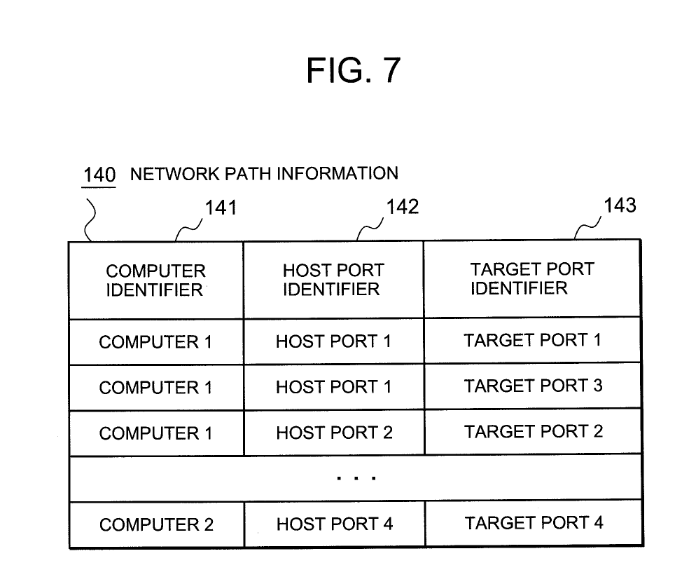

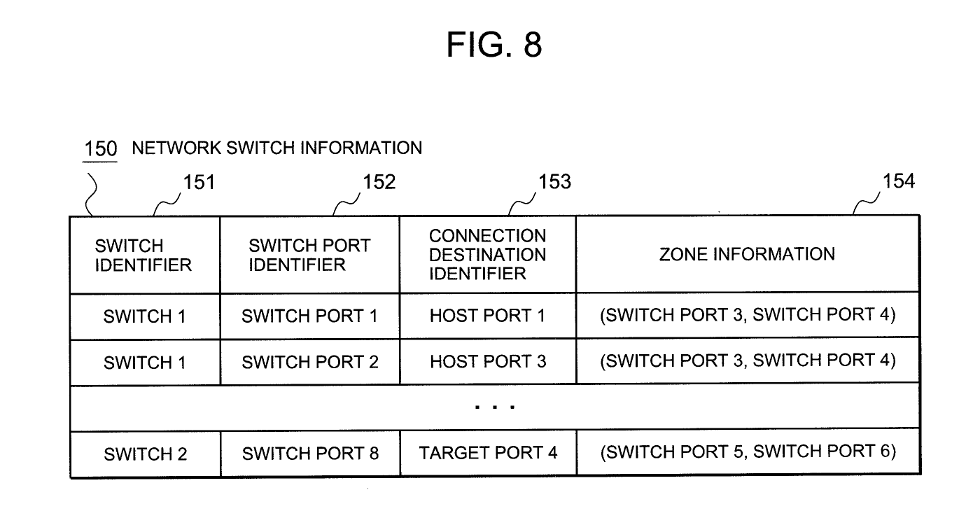

FIG. 3 is a table showing path information. FIG. 4 is a table showing switch information. FIG. 5 is a table showing a storage network. FIG. 6 is a table showing fault information. FIG. 7 is a table showing network path information. FIG. 8 is a table showing network switch information.

As shown in FIG. 3, the path information 230 is a table showing access paths from the host computer 200 to the disks 420 of the storage device 400. Each entry is constituted by a host port identifier 231 and a target port identifier 232 indicating both end points of an access path, and access path state 233 indicating the state of the access path. The access path state 233 is “normal” in the case where access to the disk 420 via the access path is possible. On the other hand, the access path state 233 is “abnormal” in the case where the access is impossible. For example, the case where access is impossible is a case where a failure of a host port, a switch unit and/or a target port on the access path or disconnection of a storage cable has occurred.

As shown in FIG. 4, the switch information 320 is a table showing the connection destination of each switch port 310 and statistical information such as the number of detected errors. Each entry is constituted by a switch port identifier 321, a connection destination identifier 322 indicating the identifier of a connection destination port of the switch port, zone information 322 storing a list of identifiers of communicable switch ports existing on the same switch unit as the switch port, and a statistical information list 324 which is a list of statistical information about the switch port. Examples of the statistical information include the number of errors detected on the port, the number of link disconnections and the like. For example, errors detected on the port include a CRC error (cyclic redundancy check, check for detecting a data error on a communication route), failure in synchronization of a signal, loss of a signal and the like.

As shown in FIG. 5, the storage network information 120 is a table showing the connection destination of each port and the state thereof. Each entry is constituted by the port identifier 121 of the port, a port classification 122, an external connection port 123, an internal connection port list 124 and a host port list 125. The port classification 122 is information for judging which of “host port”, “target port” and “switch port” the port is. The external connection port 123 stores the identifier of a port to which the port is connected by the storage cable 500. The internal connection port list 124 stores a list of identifiers of ports accessible on the same switch unit when the port is a switch port. The host port list 125 stores a list of identifiers of host ports which can be reached from the port on an arbitrary access path. The target port list 126 stores a list of identifiers of target ports which can be reached from the port on an arbitrary access path. A method for creating the storage network information 120 will be described later.

As shown in FIG. 6, the fault information 130 is a table showing information about ports where a fault has occurred. Each entry in the table is constituted by a fault port 131 indicating the identifier of a switch port where a fault has been detected, a fault host port list 132 which is a list of host ports which can be reached from the fault port on an arbitrary access path, and a fault target port list 133 which is a list of target ports which can be reached from the fault port on an arbitrary access path. A method for creating the fault information 130 will be described later. Here, a fault refers to a failure of the host port, switch unit or target port described above, or disconnection of a storage cable. In this embodiment, a fault is detected when the number of errors detected on the switch port described above, the number of link disconnections or the like exceeds a threshold.

As shown in FIG. 7, the network path information 140 is a table storing the path information 230 collected from the host computers 200. Each entry in the table is constituted by a computer identifier 141 indicating the identifier of an acquisition-source host computer 200, a host port identifier 142 and a target port identifier 143.

As shown in FIG. 8, the network switch information 150 is a table storing the switch information 320 collected from the switch units 300. Each entry in the table is constituted by a switch identifier 151 indicating the identifier of an acquisition-source switch unit 300, a switch port identifier 152, a connection destination identifier 153 and zone information 154.

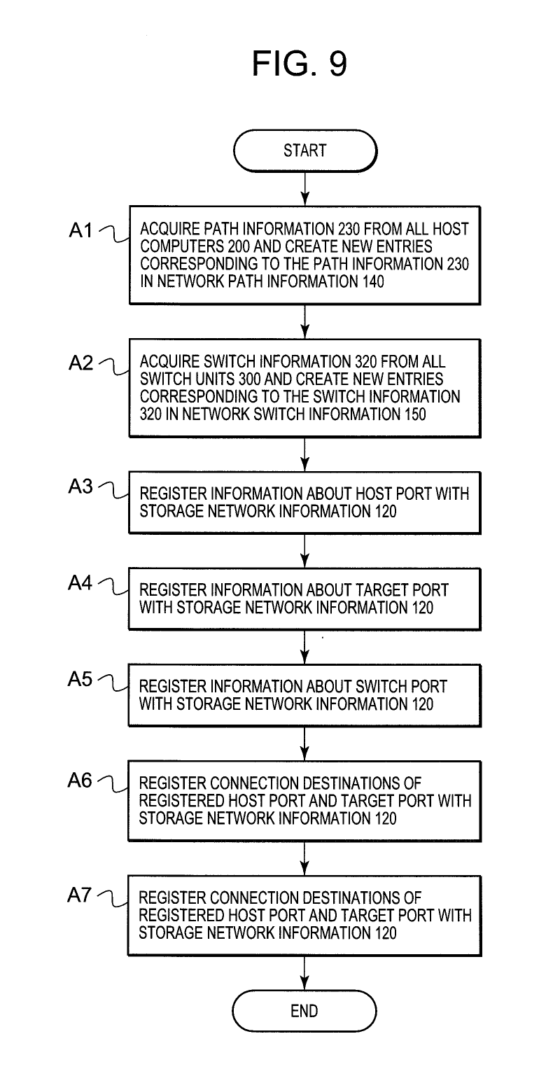

Next, a fault detection operation of the calculator system in this embodiment will be described. First, a method for the storage network management program 110 of the management computer 100 to create the storage network information 120 as initial information will be described. FIG. 9 is a flowchart showing the method for the storage network management program to create the storage network information.

As shown in FIG. 9, the storage network management program 110 acquires path information 230 from all the host computers 200 connected via the route information communication network 600 and creates new entries corresponding to the path information 230, in the network path information 140. Computer identifiers 201 are stored as the computer identifiers 141 of the new entries, and corresponding identifiers in the path information 230 are stored as the host port identifiers 142 and the target port identifiers 143 (step A1).

Next, switch information 320 is acquired from all the switch units 300 connected via the communication network 600, and new entries corresponding to the switch information 320 are created in the network switch information 150. The switch port identifiers 321 of acquisition sources are stored as the switch identifiers 151 of the new entries, and corresponding information in the switch information 320 is stored as the switch port identifiers 152, the connection destination identifiers 153 and the zone information 154 (step A2).

Information about all the host ports 210 and target ports 410 existing in the calculator system is registered with the storage network information 120 based on the network path information 140 generated at step A1.

For the host port identifier 142 existing in each entry in the network path information 140, it is confirmed whether a corresponding identifier is registered as a port identifier 121 in the storage network information 120. If there is not a corresponding identifier, a new entry is added to the storage network information 120. The host port identifier 142 is stored as a port identifier 121, and “host port” is stored as port classification 122. The fields for the other elements are left empty (step A3).

For the target port identifier 143 existing in each entry in the network path information 140, it is similarly confirmed whether a corresponding identifier is registered as a port identifier 121 in the storage network information 120. If there is not a corresponding identifier, a new entry is added to the storage network information 120. The target port identifier 143 is stored as a port identifier 121, and “target port” is stored as a port classification 122. The fields for the other elements are left empty (step A4).

Next, information about all the switch ports 310 existing in the calculator system are registered with the storage network information 120 based on the network switch information 150 generated at step A2.

For the switch port identifier 152 existing in each entry in the network switch information 150, it is confirmed whether a corresponding identifier is registered as a port identifier 121 in the storage network information 120. If there is not a corresponding identifier, a new entry is added to the storage network information 120. The switch port identifier 152 is stored as a port identifier 121, “switch port” is stored as port classification 122, the connection destination identifier 153 is stored as an external connection port 123, and the zone information 154 is stored into an internal connection port list 124. The fields for the other elements are left empty (step A5).

Through the above steps, all the ports existing in the calculator system have been registered with the storage network information 120. Next, information about connection relationships, among the ports is registered. First, information about Connection destinations of the host ports and the target ports is registered. Among the entries in the storage network information 120, such entries that the port classification 122 is “host port” or “target port” are searched for. For the port identifier 121x of such an entry x, such an entry y that the external connection port 123 corresponds to the port identifier 121x is searched for from the storage network information 120, and the port identifier 121y of the entry y is stored as the external connection port 123x of the entry x (step A6).

Next, a host port and a target port which can be reached from each port on an arbitrary access path are registered with the host port list 125 and the target port list 126 in the storage network information 120 (step A7).

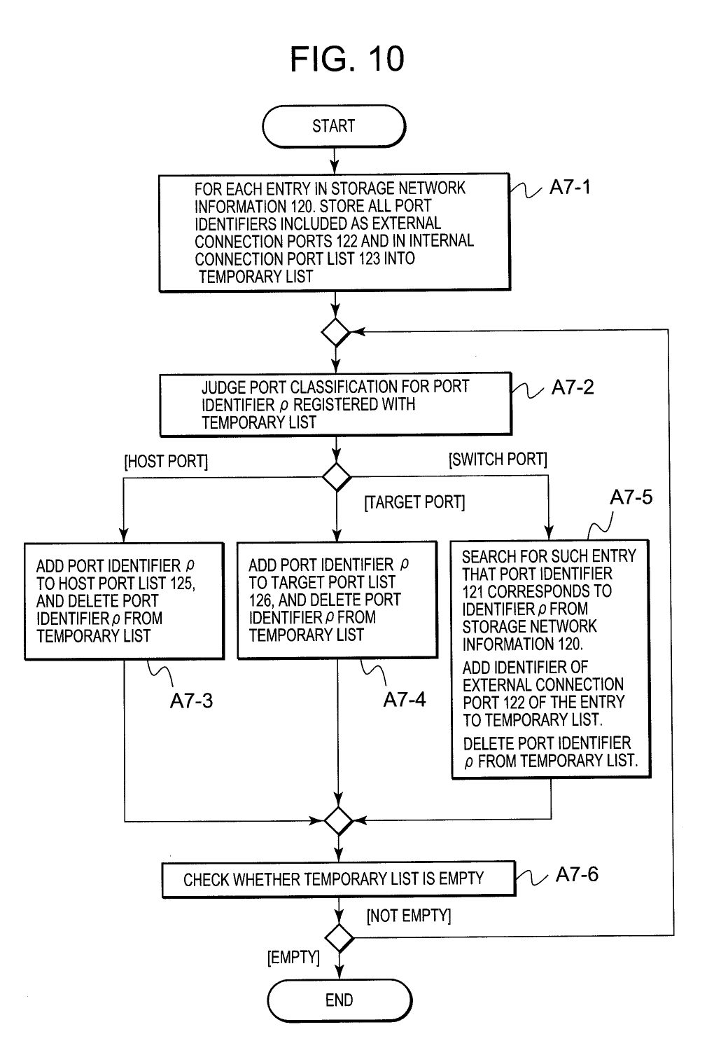

Next, a detailed registration procedure at step A7 will be described. FIG. 10 is a flowchart showing the details of the registration procedure at step A7 in FIG. 9. As shown in FIG. 10, for each entry n in the storage network information 120, all the port identifiers included in the external connection ports and the internal connection port list 124 are registered into a temporary list. An arbitrary number of port identifiers are registered with the temporary list (step A7-1).

For a port identifier p registered with the temporary list, the port classification is judged. The port identifier p is compared with the port identifier 121 of each entry in the storage network information 120, and the port classification 122 of a corresponding entry is port classification to be targeted by the judgement (step A7-2). If the judgment-target port classification is “host port”, the port identifier p is added to a host port list 125n of the entry n in the storage network information 120, and the port identifier p is deleted from the temporary list (step A7-3).

If the judgment-target port classification is “target port”, the port identifier p is added to a target port list 126n of the entry n in the storage network information 120, and the port identifier p is deleted from the temporary list (step A7-4).

If the judgment-target port classification is “switch port”, the connection destination of the connection-destination port is recursively registered. An identifier corresponding to the port identifier p is searched for from among the port identifiers 121 of the entries in the storage network information 120. The port identifier of the external connection port 123e of a relevant entry e is added to the temporary list, and the port identifier p is deleted from the temporary list (step A7-5).

It is judged whether the temporary list is empty (step A7-6). If it is not empty, the flow returns to A7-2. When the temporary list becomes empty, a host port and a target port which can be reached from a port registered with the entry n on an arbitrary access path are registered.

The creation of the storage network information 120 is completed through the above steps A1 to A7. The storage network management program 110 acquires the path information 230 about each host computer 200 and the switch information 320 about each switch unit at regular intervals. And the storage network management program 110 compares the information with the network path information 520 and network switch information 530 acquired the previous time. And the storage network management program 110 reconstructs the storage network information 120 in accordance with the procedure of the above steps A1 to A7 when there is any difference.

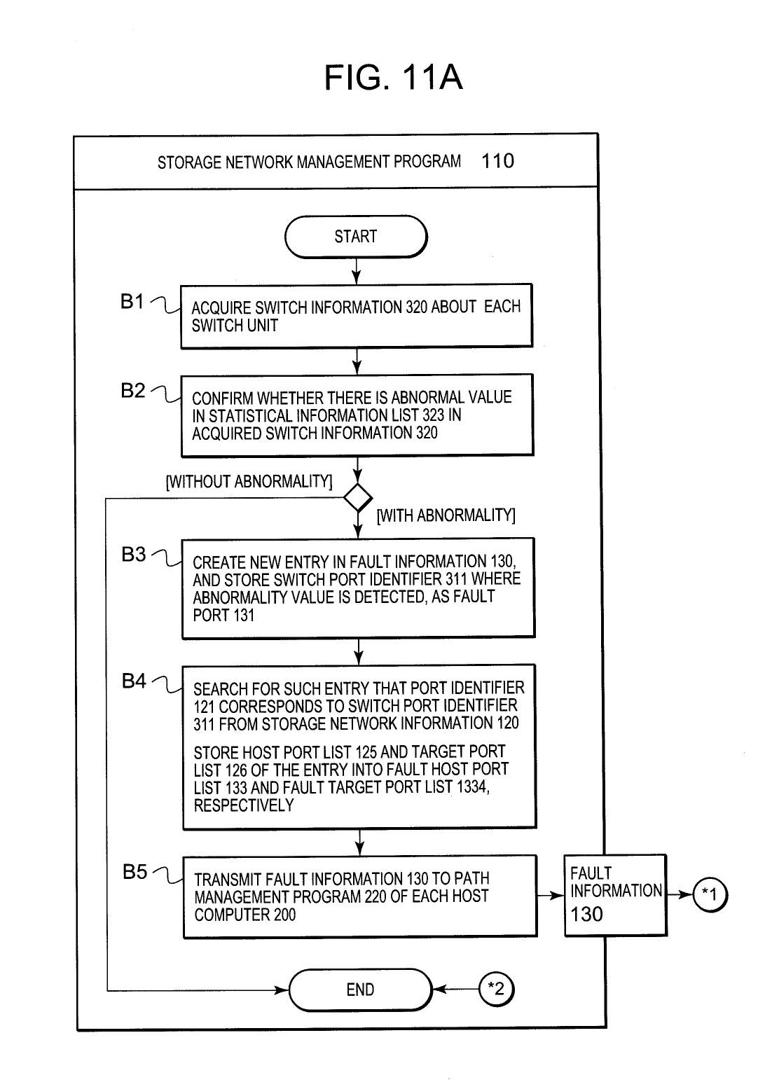

Next, a fault detection method will be described. FIGS. 11A and 11B are flowcharts showing a fault detection method according to this embodiment. In this embodiment, it is possible to detect a fault on an access path based on statistical information about switches and notify the path management program 220 on each host computer 200 that the fault has occurred.

The fault information 130 is emptied as the initial value. The storage network management program 110 of the management computer 100 acquires the switch information 320 about each switch unit at regular intervals (step B1).

For each entry s in the acquired switch information 320, the contents of a statistical information list 324s are confirmed. If an abnormality is detected based on the statistical information, for example, if the number of errors exceeds a threshold, it is assumed that a fault has occurred at a switch port identifier 321s, and the flow proceeds to the next step (step B2).

It is registered with the fault information 130 that fault has occurred at a port identified by the switch port identifier 321s. A new entry is created in the fault information 130, and the switch port identifier 321s is stored as a fault port 131 (step B3).

Such an entry e that the port identifier 121 corresponds to the switch port identifier 321s where the fault has occurred is searched for from the storage network information 120. The host port list 125e of the entry e is stored into the fault host port list 132, and the target port list 126e of the entry e is stored into the fault target port list 133 (step B4).

By repeating steps B2 to B4 for all the entries in the switch information 320, information indicating on which access path the fault-occurrence port exists is stored in the fault information 130.

The fault information 130 is notified to the path management program 220 of each host computer 200 through the communication network 600 (step B5).

The path management program 220 which has received the notification updates the path information 230 from the information in the fault information 130. For each of the entries in the fault information 130, an access path influenced by the fault is identified from all the pairs of an identifier registered with the fault host port list 132 and an identifier registered with the fault target port list 133.

For pairs of an identifier h stored in the fault host port list 132 and an identifier t stored in the fault target port list 133, such an entry that the host port identifier 231 corresponds to the identifier h, and the target port identifier 233 corresponds to the identifier t is searched for from the path information 230. The path state 2331 of the entry is changed to “fault” (step B6).

Through these steps, it is possible to update the path information 230 on each host computer 200 when a fault occurs.

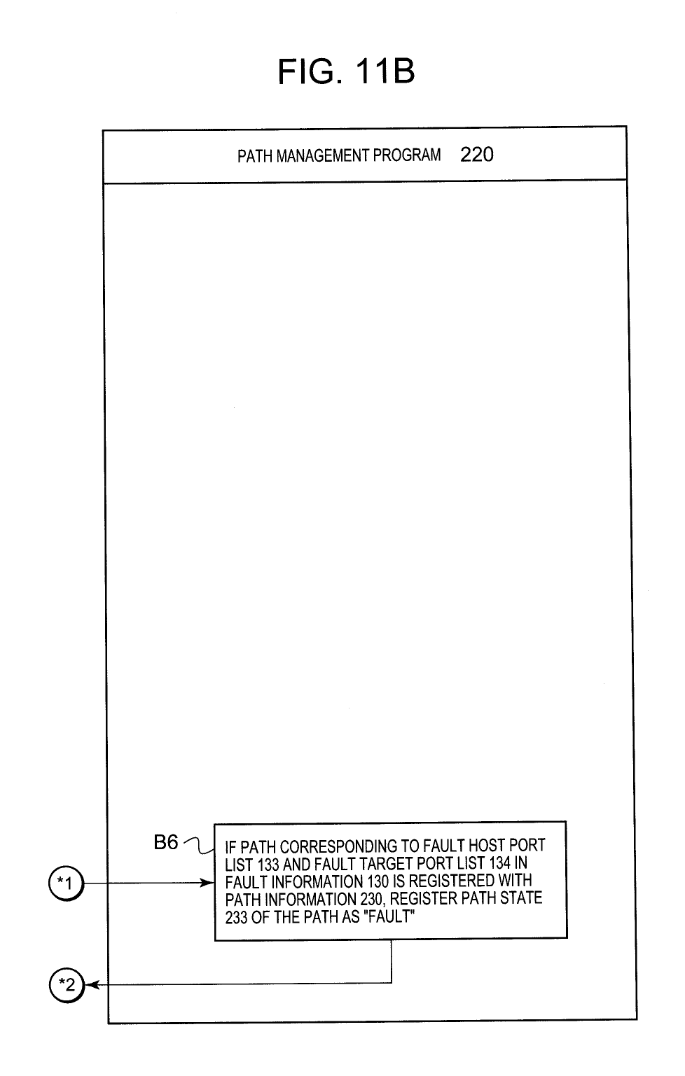

Next, the operation of this embodiment will be described with the use of a specific example. FIG. 12 is a diagram showing an example of the calculator system. As shown in FIG. 12, in this specific example, two host computers 200a and 200b are connected to a storage device 400a via two switch units 300a and 300b. The host computers 200a and 200b, the switch units 300a and 300b and the storage device 400a are connected by a storage cable 500. A management computer 100a, the two host computers 200a and 200b and the two switch units 300 and 300b are connected via a communication network 600.

As for the identifiers in this embodiment, the host port identifier of a host port 210a is indicated simply as 210a, and the switch port identifier of a switch port identifier 310a1 is indicated simply as 310a1. Other identifiers will be similarly indicated.

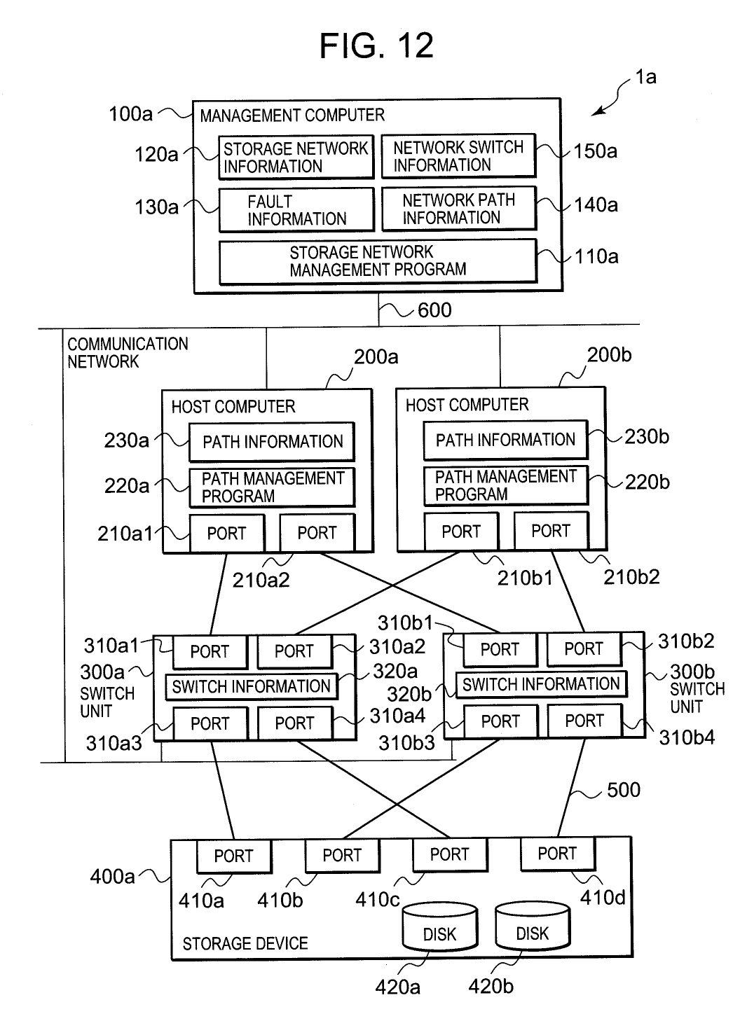

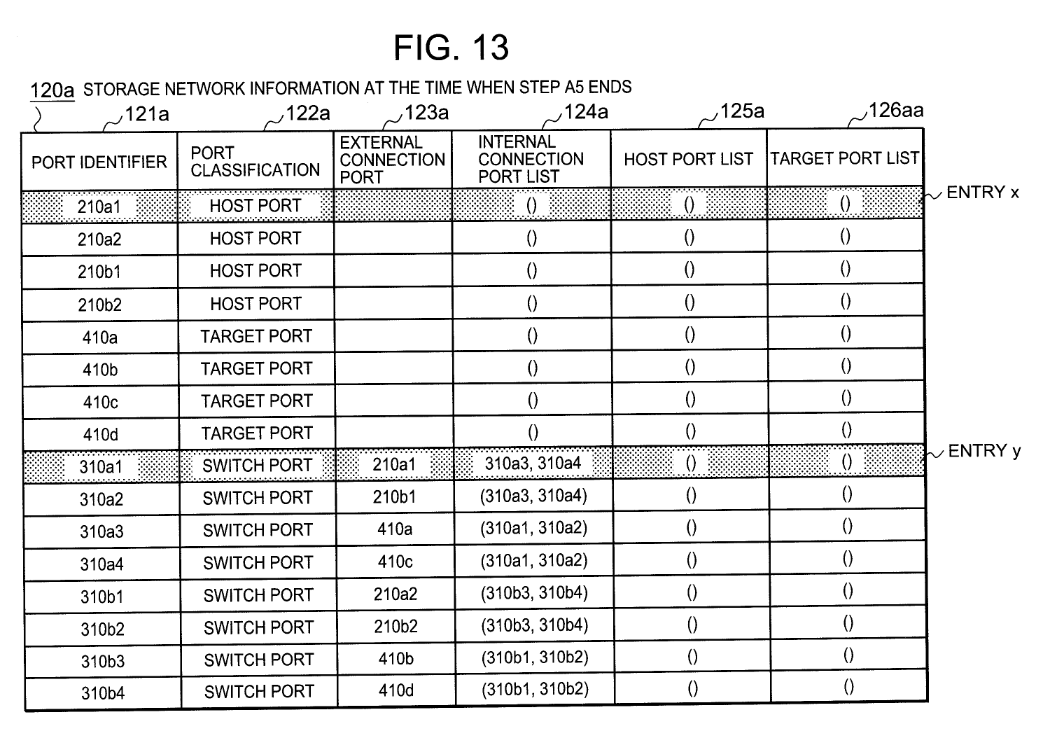

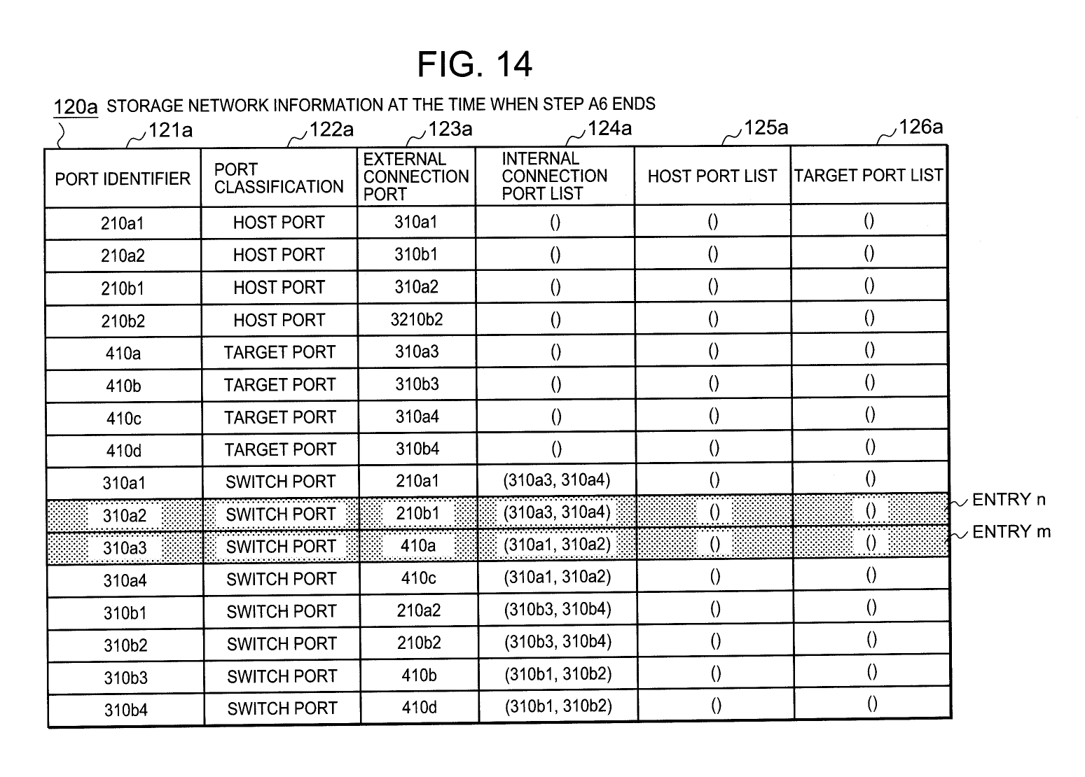

A method for creating storage network information 120a shown in FIGS. 9 and 10 will be described first. FIG. 13 shows the storage network information 120a at the time when step A5 ends. FIG. 14 shows the storage network information 120a at the time when step A6 ends. FIG. 15 shows the storage network information 120a at the time when step A7 ends.

At step A1, path information 230 is acquired from the two host computers to create network path information 140a. At step A2, switch information is acquired from the two switch units 300a and 300b to create storage switch information 150a.

At steps A3 and A4, information about host ports and target ports is registered with the storage network information 120a from the network path information 140a. At step A5, information about switch ports is registered with the storage network information 120a from the network switch information 150a. The storage network information 120a at the time when step A5 ends is as shown in FIG. 13.

Next, the operation of step A6 will be described. Since the port classification of the first entry x in the storage network information 120a shown in FIG. 13 is “host port”, registration of information about a connection destination is performed. When such an entry that the external connection port 123a corresponds to the port identifier “210a1” of the entry x is searched for from the storage network information 120a, the ninth entry y corresponds thereto.

Since the port identifier of the entry y is “310a1”, it is known that the switch port 310a1 is connected to the host port 210a1. In order to register the host port connection relationship, “310a1” is registered as the external connection port 123ax of the entry x.

The above procedure is performed for all the host ports and target ports registered with storage network information 120a1. The storage network information 120a after step A6 is as shown in FIG. 14.

At step A7, for each entry in the storage network information 120a, the contents of a host port list 125a and a target port list 126a are registered. The operation of the detailed registration procedure shown in FIG. 10 will be described, with the tenth entry n in the storage network information 120a shown in FIG. 14, that is, a switch port 310a2 as an example. At step A7-1, all the port identifiers included as the external connection ports 123an and internal connection ports 124an of the entry n are stored into a temporary list. Three ports identifiers of (210b1, 310a3 and 310a4) are stored in the temporary list.

Next, at step A7-2, the classification for the identifier 210b1 stored in the temporary list is checked. Since 210b1 is a host port, the flow proceeds to step A7-3, where the identifier 210b1 is added to the host port list 125a, and the port identifier 210b1 is deleted from the temporary list.

Following the route to the connection destination of the switch port 310a2 at this step, it is known that the host port 210b1 can be reached. At this time point, the two port identifiers of (310a3 and 310a4) are stored in the temporary list.

The flow returns to step A7-2, where the classification for the identifier 310a3 stored in the temporary list is checked. Since 310a3 is a switch port, the flow proceeds to step A7-5, where an entry m the port identifier of which corresponds to 310a3 is searched for from the storage network information 120a. In FIG. 14, the eleventh entry corresponds thereto.

A port identifier 410a included as the external connection port of the entry m is added to the temporary list. This indicates that it is possible to reach the switch port 310a3 from the switch port 310a2, and it is also possible to reach the port 410a connected beyond the switch port 310a3. From the temporary list, 310a3 is deleted. At this time point, the two port identifiers (410a and 310a4) are stored in the temporary list.

Furthermore, the flow returns to step A7-2, where the classification for the identifier 410a stored in the temporary list is checked. Since 410a is a target port, the flow proceeds to step A7-4, where the identifier 410a is added to the target port list 126a, and the port identifier 410a is deleted from the temporary list.

The above procedure is repeated until the temporary list is emptied. Since a loop does not exist on the access paths, a host port or a target port is encountered by following a route to a connection destination, and the temporary list is finally emptied. The storage network information 120a at the time when step A7 ends is as shown in FIG. 15.

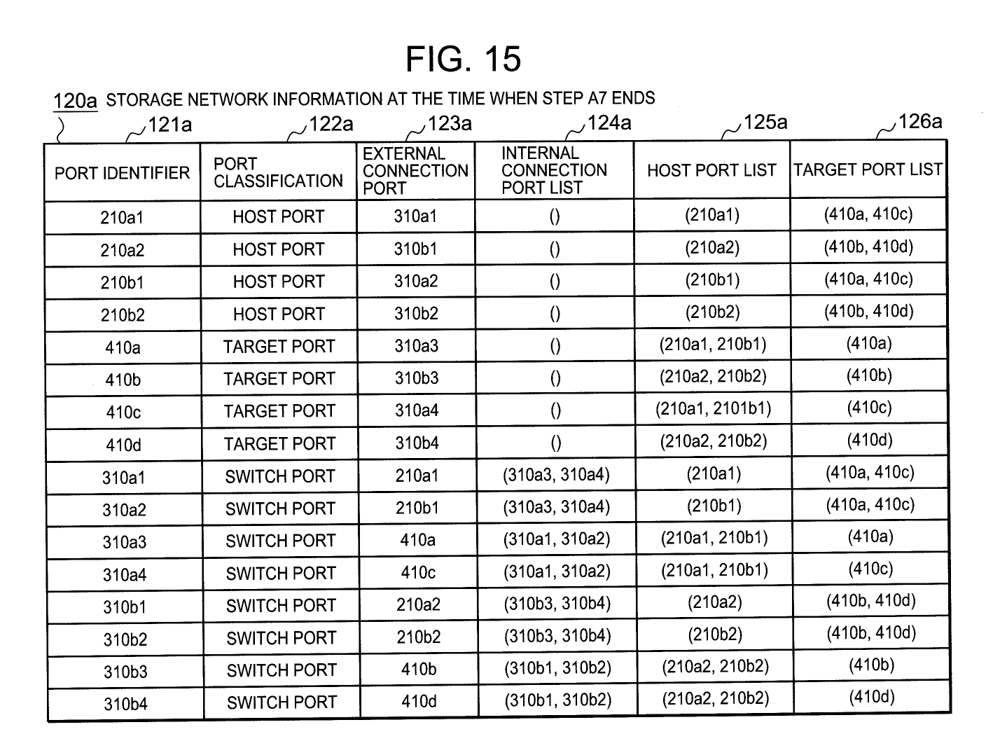

Next, the operation of fault detection means shown in FIG. 11 will be described with the use of an example. A case where a fault is detected at a switch port 310b3 will be considered. FIG. 16 is a diagram showing fault information 130a at the time when step B4 ends.

At step B1, switch information 320b is acquired, and, at step B2, it is detected that an abnormality has occurred at the switch port 310b3. At step B3, a new entry is created in the fault information 130a, and “310b3” is added as a fault port 131a.

At step B4, such an entry that the port identifier 121a is “310b3” in the storage network information 120a is searched for, and the host port list and target port list of this entry are stored as a fault host port list 132a and a fault target port list 133a, respectively. The fault information 130a at the time when step B4 ends is as shown in FIG. 16.

At step B5, a storage network management program 110a transmits the fault information 130a to path management programs 220a and 220b.

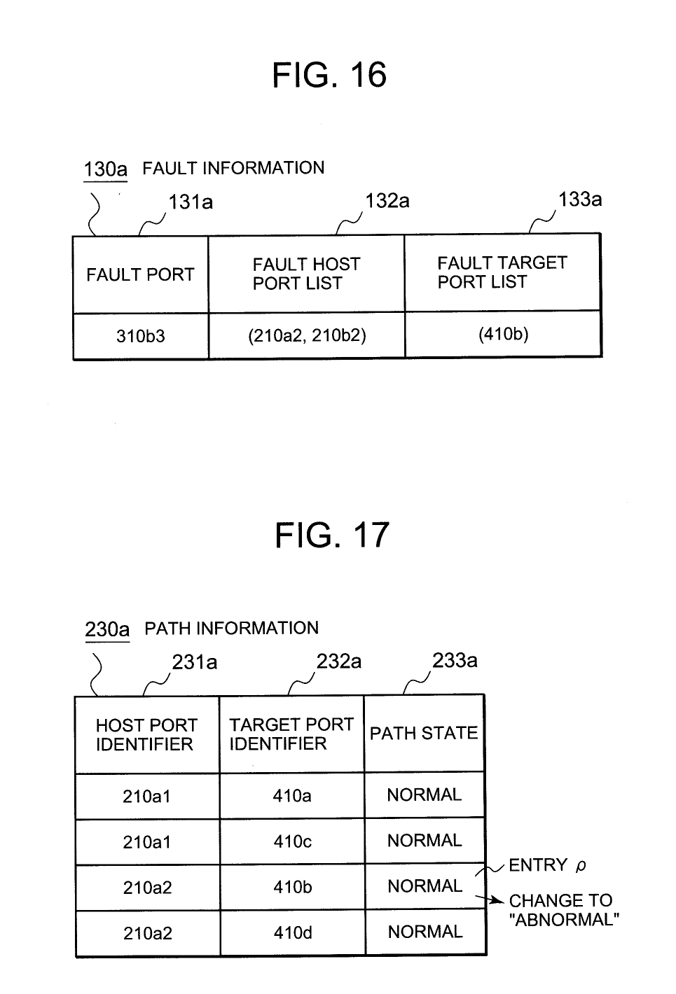

At step B6, the path management program identifies a fault path from the path information and changes the path state. Here, the operation of the path management program 220a is described as an example. FIG. 17 is a diagram showing path information 230a immediately before step B6.

There are two access path sets generated from the fault port list 132a and the fault target port list 133a in the fault information 13a: a path from a host port 210a2 to a target port 410b and a path from a host port 210b2 to the target port 410b. Referring to the path information 230a, the third entry p corresponds to the latter path. The path state 233a of the entry p is changed to “abnormal”.

According to the above procedure, the path management program 220a can detect that a fault has occurred on a path.

The advantages according to this embodiment will be described. A first advantage is that, even in a large-scale configuration in which a lot of switch units are connected, it is possible to detect such a fault that cannot be detected from a path management program. The reason is that detection is performed on the basis of statistical information about the switch units.

A second advantage is that, when a fault is detected, a path where the fault has occurred can be identified in a short time and notified to a host computer. The reason is that the storage network management program registers on which path a port exist, in advance, at the stage of initial setting before the fault occurs.

### Third Embodiment of the Present Invention

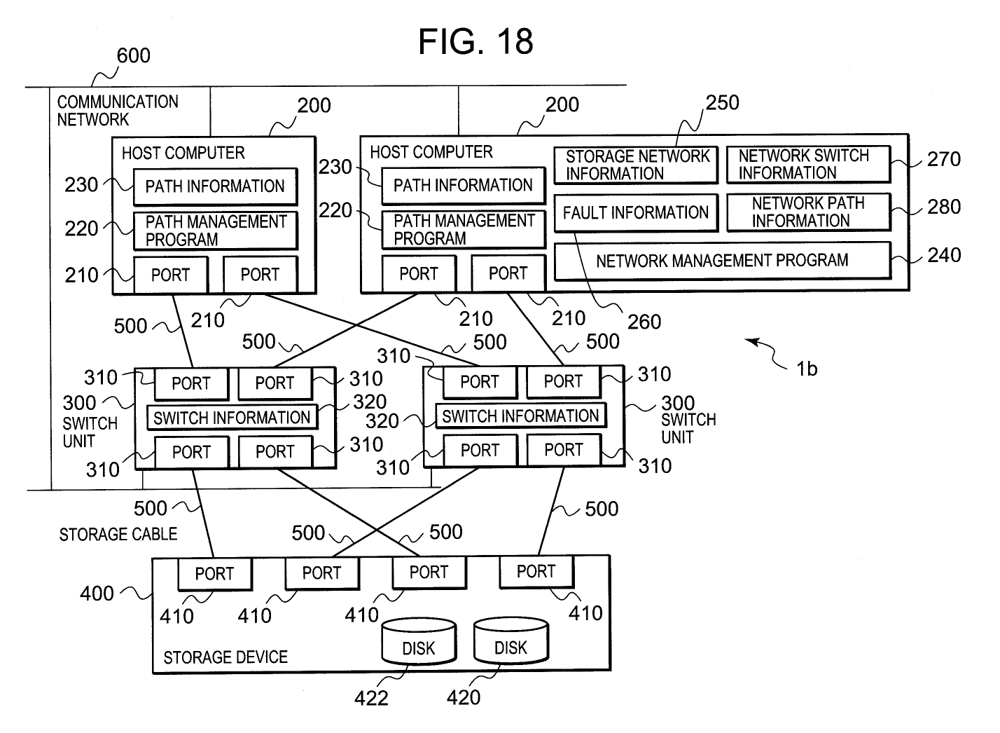

FIG. 18 is a diagram showing a calculator system 1b according to a third exemplary embodiment of the present invention. Though the management computer 100 was separated from the host computers 200, such a configuration is also possible that the storage network management program 110 is operated on any one of the host computers 200 to cause the host computer 200 to play the role of a management computer also, as shown in FIG. 18. The operation in this embodiment is the same as the operation in the second exemplary embodiment shown in FIG. 2.

The present invention is not limited to the exemplary embodiments described above. It goes without saying that various modifications are possible within the range not departing from the spirit of the present invention.

What is claimed is:

1. A communication system, comprising:
a host computer with a host port;
a switch with a switch port; and
a storage device with a storage port which is connected to the host port via the switch port,
wherein the host computer is configured to manage access path information indicating how the host port and the storage port are connected to the switch port, and identify an access path influenced by a switch fault according to the access path information when the switch fault occurs.

2. A communication system, comprising:
a host computer with a host port;
a switch with a switch port; and
a storage device with a storage port which is connected to the host port via the switch port,
wherein the host computer is configured to manage statistical information, including the number of switch faults, and detect an occurrence of the switch fault when the number of the switch faults is over a predetermined threshold.

3. The communication system according to claim 2,
wherein the host computer is configured to manage access path information indicating the host port and the storage port are connected to the switch port, and identify an access path influenced by a switch fault according to the access path information when the occurrence of the switch fault is detected.

4. The communication system according to claim 2,
wherein the statistical information includes the number of the switch port faults, and
wherein the host computer is configured to detect the occurrence of the switch fault when the number of the switch port faults is over a predetermined threshold.

5. The communication system according to claim 4,
wherein the statistical information includes the number of errors detected on the switch and the number of link disconnections on the switch.

6. The communication system according to claim 1,
wherein the storage port is configured to connect to the host port via a plurality of switch ports.

7. The communication system according to claim 2,
wherein the storage port is configured to connect to the host port via a plurality of switch ports.

8. The communication system according to claim 1,
wherein the switch port is not used more than one time in the access path.

9. The communication system according to claim 2,
wherein the switch port is not used more than one time in an access path between the host port and the storage port.

10. A communication system, comprising:
a host computer with a host port;
a switch with a switch port;
a storage device with a storage port which is connected to the host port via the switch port; and
a management computer configured to manage access path information indicating how the host port and the storage port are connected to the switch port, and identify an access path influenced by a switch fault according to the access path information when the switch fault occurs.

11. A communication system, comprising:
a host computer with a host port;
a switch with a switch port;
a storage device with a storage port which is connected to the host port via the switch port; and
a management computer configured to manage statistical information including the number of switch faults, detect an occurrence of the switch fault when the number of the switch faults is over a predetermined threshold.

12. The communication system according to claim 11,
wherein the management computer is configured to manage access path information indicating the host port and the storage port are connected to the switch port, and identify an access path influenced by a switch fault according to the access path information when the occurrence of the switch fault is detected.

13. A communication method of a communication system having a host computer with a host port, a switch with a switch port and a storage device with a storage port, comprising:
connecting the storage port to the host port via the switch port;
managing access path information indicating the host port and the storage port are connected to the switch port; and
identifying an access path influenced by a switch fault according to the access path information when the switch fault occurs.

14. A communication method of a communication system having a host computer with a host port, a switch with a switch port and a storage device with a storage port, comprising:
connecting the storage port to the host port via the switch port;
managing statistical information including the number of switch faults; and
detecting an occurrence of the switch fault when the number of the switch faults is over a predetermined threshold.

15. The communication method according to claim 14, further comprising:
managing access path information indicating the host port and the storage port are connected to the switch port; and
identifying an access path influenced by a switch fault according to the access path information when the occurrence of the switch fault is detected.

16. The communication method according to claim 14,
wherein the statistical information includes the number of the switch port faults, and
wherein the occurrence of the switch fault is detected when the number of the switch port faults is over a predetermined threshold in the detecting step.

17. The communication method according to claim 16,
wherein the occurrence of the switch fault is detected according to the statistical information including the number of errors detected on the switch and the number of link disconnections on the switch in the detecting step.

18. The communication method according to claim 13,
wherein the storage port is configured to connect to the host port via a plurality of switch ports in the connecting step.

19. The communication method according to claim 14,
wherein the storage port is configured to connect to the host port via a plurality of switch ports in the connecting step.

20. The communication method according to claim 13,
wherein the switch port is not used more than one time in the access path in the connecting step.

21. The communication method according to claim 14,
wherein the switch port is not used more than one time in an access path between the host port and the storage port.

22. A computer readable medium having recorded thereon a program for enabling a computer to carry out a method, wherein the computer has a host computer with, a host port, a switch with a switch port and a storage device with a storage port, comprising:
connecting the storage port to the host port via the switch port;
managing access path information indicating how the host port and the storage port are connected to the switch port; and
identifying an access path influenced by a switch fault according to the access path information when the switch fault occurs.

23. A computer readable medium having recorded thereon a program for enabling a computer to carry out a method, wherein the computer has a host computer with a host port, a switch with a switch port and a storage device with a storage port, comprising:
connecting the storage port to the host port via the switch port;
managing statistical information including the number of switch faults; and
detecting an occurrence of the switch fault when the number of the switch faults is over a predetermined threshold.

24. The computer readable medium having recorded thereon a program according to claim 22,
managing access path information indicating the host port and the storage port are connected to the switch port; and
identifying an access path influenced by a switch fault according to the access path information when the occurrence of the switch fault is detected.

25. The computer readable medium having recorded thereon a program according to claim 24,
wherein the statistical information includes the number of switch port faults, and
wherein the occurrence of the switch fault is detected when the number of the switch port faults is over a predetermined threshold in the detecting step.

26. The computer readable medium having recorded thereon a program according to claim 25,
wherein the occurrence of the switch fault is detected according to the statistical information including the number of errors detected on the switch and the number of link disconnections on the switch in the detecting step.

27. The computer readable medium having recorded thereon a program according to claim 22,
wherein the storage port is configured to connect to the host port via a plurality of switch ports in the connecting step.

28. The computer readable medium having recorded thereon a program according to claim 23,
wherein the storage port is configured to connect to the host port via a plurality of switch port in the connecting step.

29. The computer readable medium having recorded thereon a program according to claim 22,
wherein the switch port is not used more than one time in the access path in the connecting step.

30. The communication method according to claim 23,
wherein the switch port is not used more than one time in an access path between the host port and the storage port.
